(19) United States
(12) Patent Application Publication
(10) Pub. No.: US 2017/0297177 A1
(43) Pub. Date: Oct. 19, 2017

(54) Tool Bit for Removal and Re-Installation of Sport Utility Vehicle Removable Top Screw Knobs

(71) Applicant: Michael Philip Nizzardo, Monroe, CT (US)

(72) Inventor: Michael Philip Nizzardo, Monroe, CT (US)

(21) Appl. No.: 15/133,198

(22) Filed: Apr. 19, 2016

(51) Int. Cl. B25B 15/00; B62D 65/06

(52) U.S. Cl. CPC B25B 15/004; B62D 65/06

(57) ABSTRACT

The invention includes a bit for use in a tool or drill for removal and re-installation of a screw knob necessary to secure a removable or convertible top to a vehicle. This invention replaces the previous methods of screwing and unscrewing screw knobs by hand.

### CROSS-REFERENCE TO RELATED APPLICATIONS

This non-provisional application claims the benefit of Provisional Application No. 62/190,584 filed Jul. 9, 2015, the disclosures of which are hereby incorporated herein by reference in its entirety.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

### 1. Field of Invention

The present invention is generally directed toward the removal of vehicle removable top screw knobs and is more specifically directed toward the removal of such knobs in Jeep Wrangler and Wrangler Unlimited models.

### 2. Description of the Prior Art

Top Removal, or Convertible Enthusiasts prefer efficiency and ease when removing such tops. Currently removal of screw knobs is timely and cannot be easily done by individuals with large hands, inadequate grip, or the ability of performing repetitive twisting motion.

In vehicles with multiple steps require for complete removal of the vehicle roof (i.e. top), a reduction in time taken for any step would be desirable.

### BRIEF SUMMARY OF THE INVENTION

A tool bit for removal and re-installation of sport utility vehicle (SUV) removable top screw knobs would be desirable in that is solves the problem as in the background. Attachment to a drill or hand tool commonly available (powered or unpowered) with relative ease is the preferred method of use.

The tool bit can be used in a clockwise and counter-clockwise manner to respectively tighten or loosen the screw knob(s).

### BRIEF DESCRIPTION OF THE SEVERAL VIEWS OF THE DRAWING

FIG. 1 shows the bottom view of the bit

FIG. 2 shows the side view of the bit

FIG. 3 shows the top view of the bit

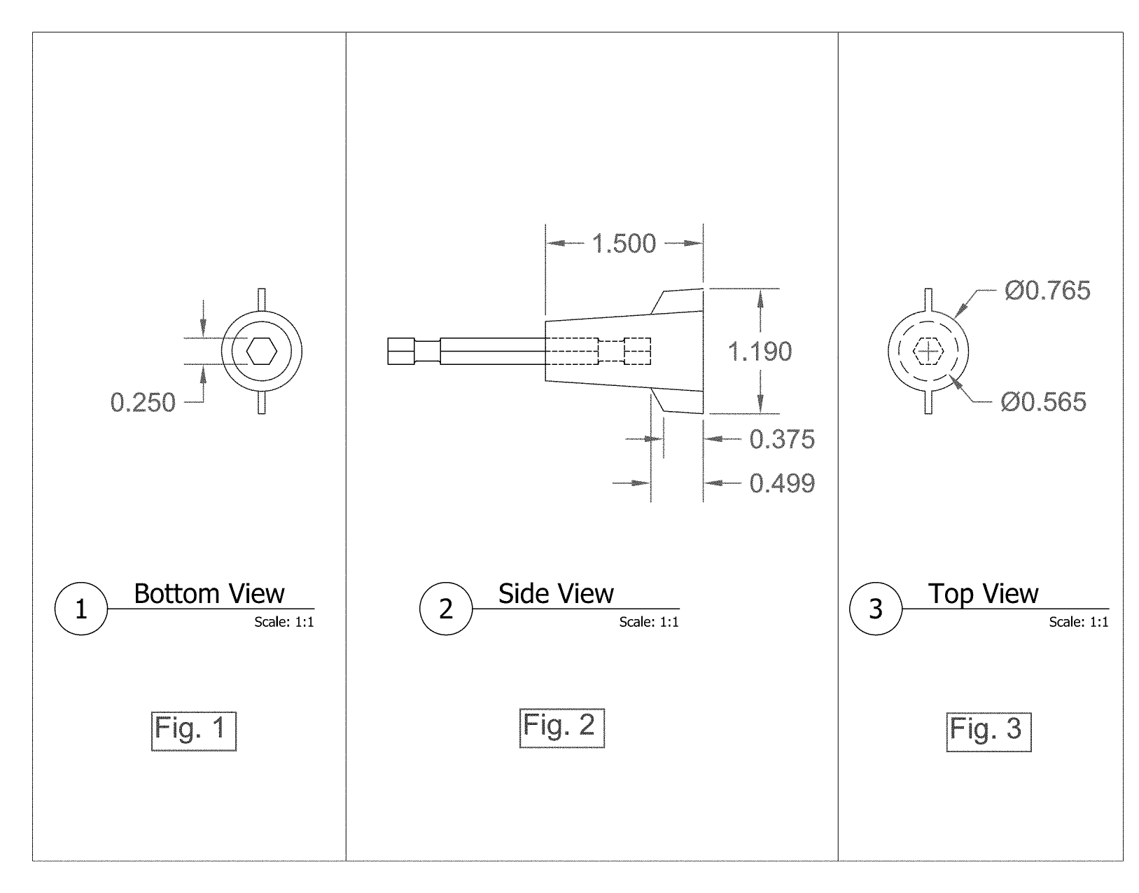

### DETAILED DESCRIPTION OF THE INVENTION

The tool bit shall be made of a plastic tip which will come in contact with the screw knob and will have a plastic or steel standard ½″ hex shank for compatibility with a variety of drills and hand tools.

Processes for fabrication of part shall be injection molding for the plastic tip or full assembly if the hex shank makeup is decided to be plastic.

Steel shank shall be crafted using precision machining and assembled to plastic tip using high strength epoxy. Plastic can also be molded around the steel shank.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

1. A tool bit comprising: an elongated hex shaft; and a plastic tip shaped as a fit to a screw knob.

2. The invention of claim 1 wherein the shaft is made of steel.

3. The invention of claim 2 wherein the shaft contains a quick release groove for ease in switching out drivers.
